(19) United States
(12) Patent Application Publication
(10) Pub. No.: US 2013/0223896 A1
(43) Pub. Date: Aug. 29, 2013

(54) IMAGE FORMING APPARATUS

(71) Applicants: Shuichi NISHIDE, Kanagawa (JP); Masahiro SATO, Kanagawa (JP); Tetsuji OKAMOTO, Kanagawa (JP); Atsushi OGIHARA, Kanagawa (JP); Koichi WATANABE, Kanagawa (JP); Wataru SUZUKI, Kanagawa (JP); Atsuyuki KITAMURA, Kanagawa (JP)

(72) Inventors: Shuichi NISHIDE, Kanagawa (JP); Masahiro SATO, Kanagawa (JP); Tetsuji OKAMOTO, Kanagawa (JP); Atsushi OGIHARA, Kanagawa (JP); Koichi WATANABE, Kanagawa (JP); Wataru SUZUKI, Kanagawa (JP); Atsuyuki KITAMURA, Kanagawa (JP)

(73) Assignee: FUJI XEROX CO., LTD., Tokyo (JP)

(21) Appl. No.: 13/564,485

(22) Filed: Aug. 1, 2012

(30) Foreign Application Priority Data
Feb. 23, 2012 (JP) 2012-037706

(51) Int. Cl. G03G 15/01

(52) U.S. Cl. 399/304

(57) ABSTRACT

An image forming apparatus includes an image carrier, a transfer body, an elastic layer, a gripper, and a pressing member. The gripper is located in a cutout region in which a cutout is formed. The gripper grips a leading end portion of the recording medium wrapped around the transfer body and releases the leading end portion that is to be separated from the transfer body. At least part of the pressing member is located closer to a trailing-end side of the recording medium than the gripper. The pressing member presses a leading end side of the recording medium, whose leading end portion is gripped by the leading-end gripper, against the elastic layer.

### CROSS-REFERENCE TO RELATED APPLICATIONS

This application is based on and claims priority under 35 USC 119 from Japanese Patent Application No. 2012-037706 filed Feb. 23, 2012.

### BACKGROUND

The present invention relates to an image forming apparatus.

### SUMMARY

An image forming apparatus according to an aspect of the invention includes an image carrier on whose surface toner images are formed while the image carrier is rotating, a transfer body around whose outer peripheral surface a recording medium is wrapped, the transfer body rotating at a peripheral velocity that is lower than a peripheral velocity of the image carrier, the transfer body transporting the recording medium, while rotating, to a transfer position at which the transfer body faces the image carrier, the outer peripheral surface including an elastic layer having a cutout being formed therein, the elastic layer being elastically deformed by being pressed by the image carrier at the transfer position while supporting the recording medium, a gripper that is disposed in a cutout region in which the cutout is formed, the gripper gripping a leading end portion of the recording medium wrapped around the transfer body and releasing the leading end portion of the recording medium that is to be separated from the transfer body, and a pressing member at least part of which is located closer to a trailing-end side of the recording medium than the gripper, the pressing member pressing a leading end side of the recording medium, whose leading end portion is gripped by the gripper, against the elastic layer.

### BRIEF DESCRIPTION OF THE DRAWINGS

An exemplary embodiment of the present invention will be described in detail based on the following figures, wherein:

FIGS. 1A and 1B illustrate a leading-end gripper of an image forming apparatus according to an embodiment that is positioned in a releasing state and in a gripping state, respectively, when viewed from a side;

FIGS. 2A and 2B illustrate a transfer drum, the leading-end gripper, and a trailing-end gripper of the image forming apparatus according to the embodiment when viewed in plan and from a side, respectively;

FIGS. 3A and 3B schematically illustrate a configuration of the trailing-end gripper of the image forming apparatus according to the embodiment;

FIGS. 4A and 4B schematically illustrate a configuration of the transfer drum and the trailing-end gripper of the image forming apparatus according to the embodiment;

FIGS. 5A, 5B, 5C, and 5D illustrate a series of states in which a sheet medium P is wrapped around the transfer drum of the image forming apparatus according to the embodiment;

FIGS. 6A, 6B, 6C, and 6D illustrate a series of states in which a sheet medium P that has been wrapped around the transfer drum of the image forming apparatus according to the embodiment is separated from the transfer drum;

FIG. 7 schematically illustrates the surroundings of a transfer position Tr of the image forming apparatus according to the exemplary embodiment;

FIG. 8 schematically illustrates the image forming apparatus according to the embodiment; and

FIG. 9 schematically illustrates the vicinity of an exemplary modification of the leading-end gripper of the image forming apparatus according to the embodiment.

### DETAILED DESCRIPTION

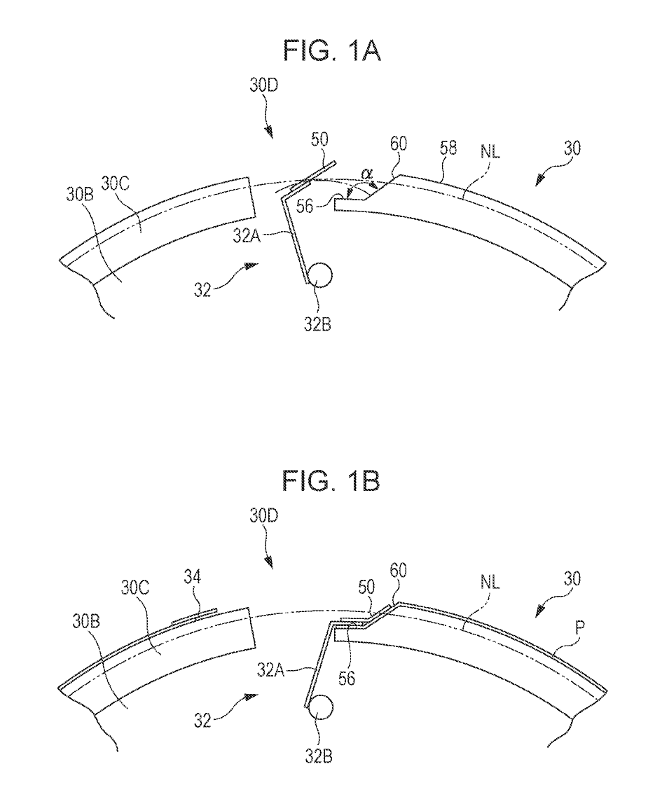

Referring to FIGS. 1A to 8, an image forming apparatus 10 according to an exemplary embodiment of the present invention will be described.

### Entire Configuration

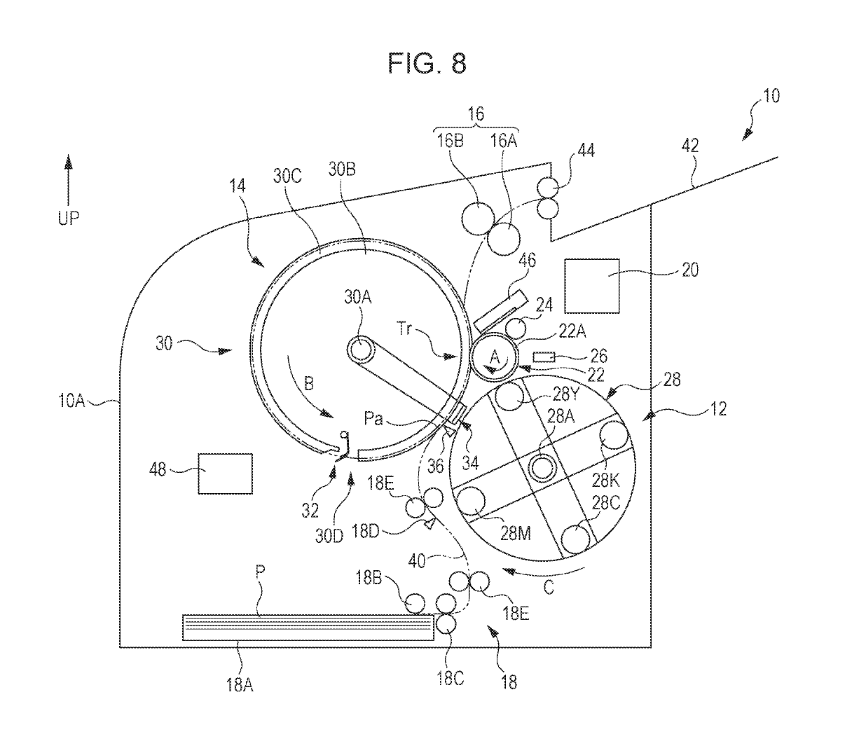

As illustrated in FIG. 8, the image forming apparatus 10 according to the exemplary embodiment of the present invention includes an image forming unit 12, a transfer device 14, a fixing device 16, a sheet feeding unit 18, and a controlling unit 20. The image forming unit 12 forms a toner image. A sheet medium P is a recording medium and is fed to the transfer device 14, and the transfer device 14 transfers the toner image, having been formed thereon by the image forming unit 12, to the sheet medium P that is wrapped around the transfer device 14. The fixing device 16 fixes the toner image, having been formed on the sheet medium P released from the transfer device 14, onto the sheet medium P. The sheet feeding unit 18 feeds the sheet medium P to the transfer device 14. The controlling unit 20 controls the entirety of the image forming apparatus 10.

### Image Forming Unit

The image forming unit 12 that forms a toner image will be described first.

The image forming unit 12 includes an image carrier 22, on whose surface toner images are sequentially formed while the image carrier 22 is rotating. The image forming unit 12 also includes a charging device 24, an exposing device 26, a rotary developing device 28, and a cleaning device 46. The charging device 24 charges the surface of the image carrier 22. The exposing device 26 exposes the charged surface of the image carrier 22 to light to form an electrostatic latent image. The rotary developing device 28 develops the electrostatic latent image, having been formed on the surface of the image carrier 22, by using a developer into a toner image. The cleaning device 46 cleans remnants remaining on the image carrier 22.

### Image Carrier

The image carrier 22 is disposed so as to rotate in the arrow A direction and includes a negatively charged photosensitive layer 22A on the surface. The charging device 24, the exposing device 26, the rotary developing device 28, and the cleaning device 46 are arranged around the image carrier 22 in this order in the arrow A direction. A driving source (not illustrated) that drives the image carrier 22 to rotate at a peripheral velocity V1 is also provided.

### Charging Device

The charging device 24 is arranged so as to face the image carrier 22. While the charging device 24 is driven to rotate by the rotating image carrier 22, the charging device 24 charges the surface of the image carrier 22.

### Exposing Device

The exposing device 26 irradiates the surface of the image carrier 22 having been charged by the charging device 24 with light to form an electrostatic latent image. In this exemplary embodiment, the exposing device 26 includes, for example, multiple light emitting diodes (LEDs, which are not illustrated).

### Rotary Developing Device

The rotary developing device 28 includes a rotation shaft 28A and developing portions 28Y, 28M, 28C, and 28K for yellow (Y), magenta (M), cyan (C), and black (K) arranged around the rotation shaft 28A. The rotary developing device 28 rotates in the arrow C direction around the rotation shaft 28A.

In the rotary developing device 28, each of the developing portions 28Y, 28M, 28C, and 28K is positioned at a position opposite the image carrier 22. The rotary developing device 28 then sequentially develops the electrostatic latent images on the image carrier 22, having been formed by the exposing device 26, into toner images of the different colors.

These developing portions 28Y, 28M, 28C, and 28K contain developers of corresponding colors.

### Cleaning Device

The cleaning device 46 recovers toner remaining on the surface of the image carrier 22 without being transferred to the sheet medium P by the transfer device 14, which will be described below, or other extraneous matters from the surface of the image carrier 22. The cleaning device 46 according to the exemplary embodiment is a blade-type cleaner.

### Transfer Device

Now, description will be given on the transfer device 14 around which a sheet medium P is wrapped and that transfers a toner image having been formed thereon by the image forming unit 12 to the wrapped sheet medium P.

The transfer device 14 includes a transfer drum 30, a leading-end gripper 32, and a trailing-end gripper 34. The transfer drum 30 is taken as an example of a transfer body around which a sheet medium P, to which a toner image on the image carrier 22 is transferred, is wrapped. The leading-end gripper 32 is taken as an example of a gripper that grips a leading end portion of the sheet medium P that is wrapped around the transfer drum 30. The trailing-end gripper 34 is taken as an example of a pressing member that controls the position of a trailing end portion of the sheet medium P.

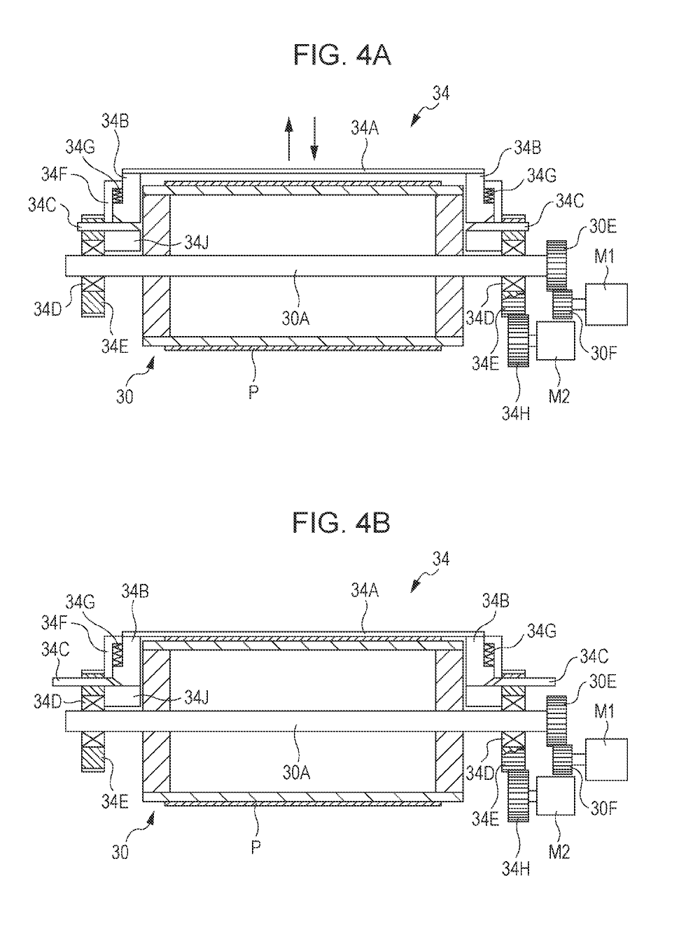

The transfer device 14 also includes a sheet sensor 36 that detects a sheet medium P passing thereby, a driving motor M1 (see FIGS. 4A and 4B) that drives the transfer drum 30 to rotate, and a power source 48 that applies a transfer bias, which is a voltage of a polarity opposite to that of the toner, to the transfer drum 30.

### Transfer Drum

The transfer drum 30 arranged so as to face the image carrier 22 includes a rotation shaft 30A, a drum-shaped base portion 30B, and an elastically deformable elastic layer 30C that is formed around the outer peripheral surface of the base portion 30B.

The elastic layer 30C, from a leading end to a trailing end of the elastic layer 30C in a direction in which the sheet medium P is transported, contiguously lies on the outer periphery of the drum-shaped base portion 30B. A portion of the transfer drum 30, around which even a maximum-size sheet medium P is not wrapped, is a cutout region 30D in which the elastic layer 30C is cut out in the peripheral direction of the transfer body.

The dimensions of the components and the positional relationships between the components are determined such that the transfer drum 30 and the image carrier 22 do not contact each other when the cutout region 30D of the transfer drum 30 faces the image carrier 22. A dielectric substance, such as a dielectric sheet, is not attached to the outer peripheral surface of the elastic layer 30C, and thus wrapping of a sheet medium P around the transfer drum 30 does not involve the use of electrostatic attraction.

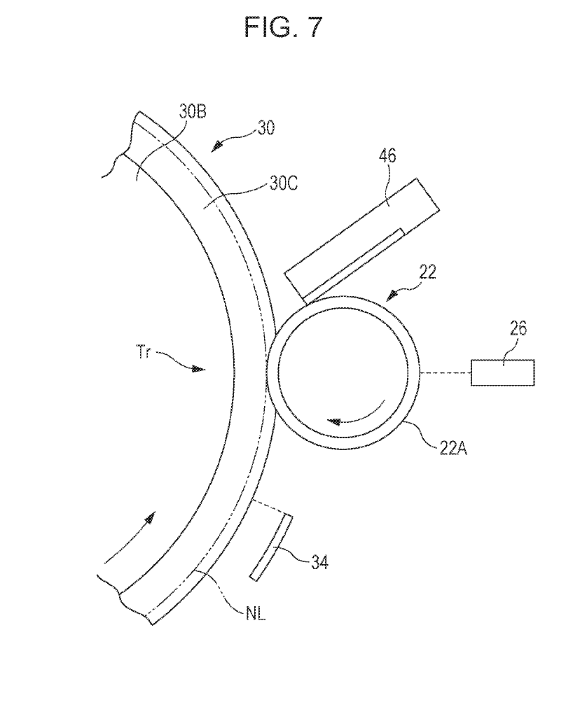

As illustrated in FIG. 7, at a transfer position Tr at which the transfer drum 30 and the image carrier 22 face each other to transfer a toner image to the sheet medium P, the elastic layer 30C of the transfer drum 30 is pressed by the image carrier 22. The elastic layer 30C is then pressed by the image carrier 22 down to a compressed circumference NL illustrated in FIG. 7 with the two-dot chain line.

At the transfer position Tr, transporting of the sheet medium P that is nipped by the transfer drum 30 and the image carrier 22 is dominantly performed by using electrostatic attraction of the image carrier 22.

As illustrated in FIGS. 4A and 4B, a gear 30E is mounted on an end portion of the rotation shaft 30A of the transfer drum 30 and engages with a gear 30F mounted on an output shaft of the driving motor M1, which drives the transfer drum 30 to rotate. The transfer drum 30 is driven to rotate by the driving force of the driving motor M1 at a peripheral velocity V2, which is lower than a peripheral velocity V1 of the image carrier 22.

### Sheet Sensor

As illustrated in FIG. 8, the sheet sensor 36 is arranged so as to face the outer peripheral surface of the transfer drum 30. The sheet sensor 36 irradiates the sheet medium P, which is transported while being wrapped around the transfer drum 30, with infrared light, and detects the sheet medium P passing thereby using the reflected light.

The sheet sensor 36 is disposed on a side that is further upstream, in the direction in which the sheet medium P is transported, than a stand-by position of the trailing-end gripper 34 (the position of the trailing-end gripper 34 illustrated in FIG. 8), which will be described below, and on a side that is further downstream, in the direction in which the sheet medium P is transported, than a feeding-sheet position Pa at which a sheet medium P is fed to the transfer drum 30.

### Leading-End Gripper

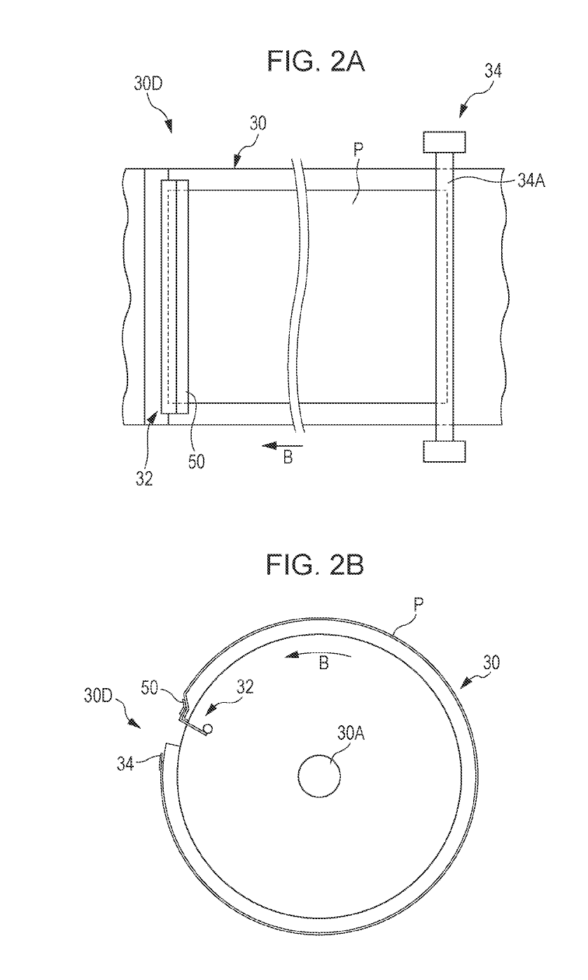

As illustrated in FIGS. 2A and 2B, the leading-end gripper 32 that grips the leading end portion of the sheet medium P wrapped around the transfer drum 30 is attached to the transfer drum 30, and is disposed in the cutout region 30D. FIG. 2A is a development drawing in which the outer periphery of the transfer drum 30 is developed.

As illustrated in FIGS. 1A and 1B, the leading-end gripper 32 includes a pressing plate 32A and a shaft member 32B. The pressing plate 32A presses the leading end portion of the sheet medium P against the elastic layer 30C. The shaft member 32B causes the pressing plate 32A to rotate such that a leading end portion of the sheet medium P is griped or released.

The pressing plate 32A extends in a direction of a rotation axis of the transfer drum 30 (or may simply be referred to as a “drum axis direction”, below). For example, the pressing plate 32A is formed by bending a stainless steel plate, and has a single bent portion when viewed in the drum axis direction.

An axis direction of the shaft member 32B is along the drum axis direction. The shaft member 32B, which is cylindrical, is secured to a first end portion of the pressing plate 32A. Accordingly, when the shaft member 32B is rotated, the leading-end gripper 32 moves so as to switch between a gripping state, in which a second end portion of the pressing plate 32A grips the leading end portion of the sheet medium P (see FIG. 1B), and a releasing state, in which the second end portion releases the leading end portion of the sheet medium P (see FIG. 1A).

As illustrated in FIGS. 1A and 1B, a locus of the leading-end gripper 32 that moves so as to switch between the gripping state and the releasing state is formed on the inner side of the compressed circumference NL, and thus the leading-end gripper 32 does not contact the image carrier 22. In other words, the leading-end gripper 32 is located outside a region within which the image carrier 22 compresses the elastic layer 30C, and thus when the leading-end gripper 32 has been moved to the transfer position Tr, the leading-end gripper 32 is separated from the image carrier 22.

A film-formed pressing member 50 is attached to the pressing plate 32A. The film-formed pressing member 50 presses the leading-end side of the sheet medium P, whose leading end portion is gripped by the leading-end gripper 32, against the elastic layer 30C.

The pressing member 50 and the shape of a portion of the elastic layer 30C, the leading-end portion of the sheet medium P being gripped between the elastic layer 30C and the leading-end gripper 32, will be described in detail below.

### Trailing-End Gripper

As illustrated in FIGS. 2A and 2B, the trailing-end gripper 34 is stretched across the transfer drum 30 in the drum axis direction, and rotates around the rotation shaft 30A independently of the transfer drum 30.

As illustrated in FIGS. 4A and 4B, the trailing-end gripper 34 includes a sheet controlling portion 34A extending in the drum axis direction, and holding portions 34B that hold both end portions of the sheet controlling portion 34A. The sheet controlling portion 34A stops the trailing end portion of the sheet medium P from moving.

The sheet controlling portion 34A is made of a film-formed resin material and is elastically deformable. Examples of the resin material include polyethylene terephthalate (PET), polyimide, and fluorocarbon resins.

The holding portions 34B extend in the radial direction of the transfer drum 30 (also simply referred to as a “drum radial direction”, below). The trailing-end gripper 34 also includes wedge-shaped shifting members 34C, whose movement in the drum axis direction causes the sheet controlling portion 34A to move in the drum radial direction via the holding portions 34B.

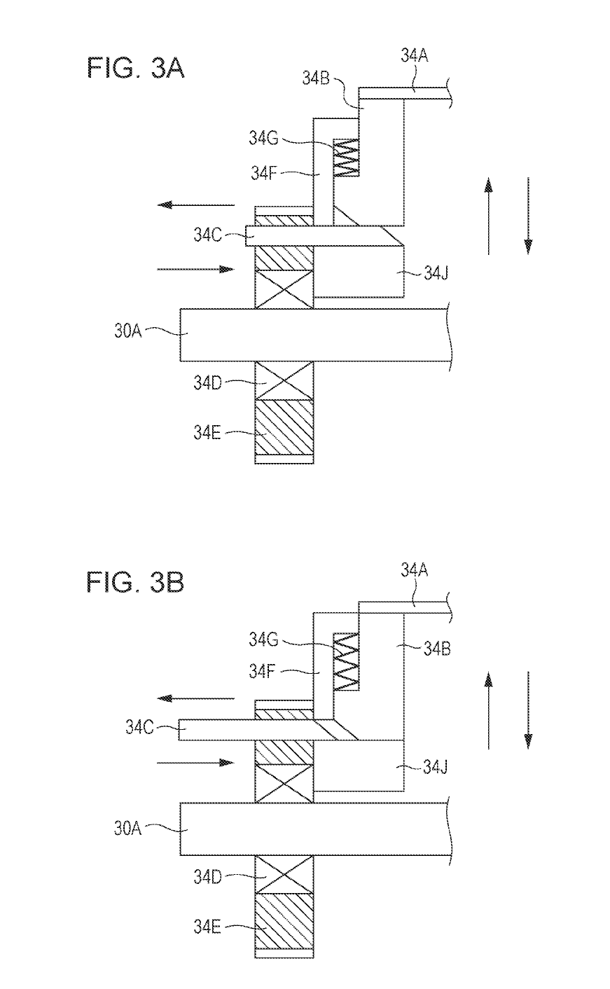

As illustrated in FIGS. 3A and 3B, gears 34E are attached to the rotation shaft 30A via bearings 34D, and supporting portions 34F extending in the drum radial direction are attached to the gears 34E. Each holding portion 34B is disposed so as to be movable with respect to a corresponding one of the supporting portions 34F in the drum radial direction. A spring member 34G is interposed between each holding portion 34B and a corresponding supporting portion 34F, the spring member 34G urging the holding portion 34B in a radially inward direction. The trailing end gripper 34 also includes stopper portions 34J that control the positions of the holding portions 34B when being contacted by the holding portions 34B having been urged by the spring members 34G in the radially inward direction.

In this configuration, when the controlling unit 20 controls a solenoid, which is not illustrated, to move the wedge-shaped shifting members 34C in the drum axis direction and insert each of the wedge-shaped shifting members 34C between one of the holding portions 34B and a corresponding stopper portion 34J, the holding portions 34B are moved in a radially outward direction. With this operation, the sheet controlling portion 34A switches to the releasing state, in which the sheet controlling portion 34A becomes separated from the elastic layer 30C to release the trailing end portion of the sheet medium P (see FIGS. 3A and 4A).

On the other hand, when the controlling unit 20 controls a solenoid, which is not illustrated, to move the wedge-shaped shifting members 34C in the drum axis direction and pull out each of the wedge-shaped shifting members 34C from between one of the holding portions 34B and a corresponding stopper portion 34J, the holding portions 34B are moved in a radially inward direction. With this operation, the sheet controlling portion 34A switches to the controlling state in which the sheet controlling portion 34A brings the sheet medium P into contact with the elastic layer 30C such that the sheet medium P contiguously lies on the elastic layer 30C (see FIGS. 3B and 4B).

As illustrated in FIGS. 4A and 4B, a driving motor M2 that drives the trailing-end gripper 34 to rotate around the rotation shaft 30A is provided, and a gear 34H that is mounted on an output shaft of the driving motor M2 engages with one of the gears 34E.

As described above, since the trailing-end gripper 34 is disposed as a body that is separate from the transfer drum 30, the position of the trailing-end gripper 34 is changeable with respect to the transfer drum 30.

When the leading-end gripper 32 grips the leading end portion of the sheet medium P, the leading-end gripper 32 does not allow the sheet medium P to move in the transporting direction and stops the sheet medium P from being separated from the transfer drum 30. On the other hand, when the trailing-end gripper 34 controls the trailing end portion of the sheet medium P, the trailing-end gripper 34 allows the sheet medium P to move in the transporting direction but stops the sheet medium P from being separated from the transfer drum 30.

### Fixing Device

The fixing device 16 that fixes a toner image formed on a sheet medium P onto the sheet medium P will be described now.

As illustrated in FIG. 8, the fixing device 16 includes a heating roller 16A and a pressurizing roller 16B. The heating roller 16A includes a heating source (not illustrated) and a rotating force is transmitted to the heating roller 16A. The pressurizing roller 16B is in contact with the heating roller 16A with pressure.

When a sheet medium P holding a toner image is nipped between and transported by the heating roller 16A and the pressurizing roller 16B, the toner image is melted and pressurized and is thus fixed onto the sheet medium P.

Discharging rollers 44 are disposed on a side that is further downstream than the fixing device 16 in the direction in which the sheet medium P is transported. The discharging rollers 44 discharge the sheet medium P, having a toner image fixed thereon, to a discharge portion 42 formed on an upper surface of an apparatus body 10A.

### Sheet Feeding Unit

Now, the sheet feeding unit 18 that feeds a sheet medium P to the transfer device 14 will be described.

The sheet feeding unit 18 is disposed at a lower portion in the apparatus body 10A of the image forming apparatus 10 and includes a sheet containing member 18A, a pick-up roller 18B, separation rollers 18C, and a leading-end sensor 18D. The sheet containing member 18A contains sheet media P. The pick-up roller 18B picks up the sheet media P from the sheet containing member 18A. The separation rollers 18C separate closely attached sheet media P from each other. The leading-end sensor 18D detects the leading end portion of a sheet medium P passing thereby.

The sheet feeding unit 18 also includes multiple transporting rollers 18E. Each sheet medium P is transported by the transporting rollers 18E along a transport path 40.

In this manner, each sheet medium P is transported along the transport path 40 from the sheet containing member 18A to the feeding-sheet position Pa, which is positioned on a side that is further upstream than the transfer position Tr in the direction of rotation of the transfer drum 30.

### Operations of Entire Configuration

Now, operations of the entire configuration will be described.

Firstly, color image data that has been formed by a personal computer or the like, which is not illustrated, is input to an image signal processor (not illustrated) as red (R), green (G), and blue (B) data, for example, and is then subjected to image processing. The image data that has been subjected to image processing is converted into four-color gradation data for yellow (Y), magenta (M), cyan (C), and black (K), which is output to the exposing device 26, so that an image forming operation is started.

As illustrated in FIG. 8, with the start of the image forming operation, the image carrier 22 and the transfer drum 30 start rotating together. Here, the peripheral velocity V1 of the image carrier 22 is higher than the peripheral velocity V2 of the transfer drum 30. For example, the peripheral velocity V1 of the image carrier 22 is approximately 0.5% to 1% higher than the peripheral velocity V2 of the transfer drum 30.

At this time, the leading-end gripper 32 and the trailing-end gripper 34 are in the releasing state.

While the leading-end gripper 32 rotates together with the transfer drum 30, the trailing-end gripper 34 remains stationary at the stand-by position without rotating together with the transfer drum 30 while being in the releasing state.

The photosensitive layer 22A of the rotating image carrier 22 is charged by the charging device 24. The exposing device 26 then irradiates the image carrier 22 with light so that an electrostatic latent image for a first color (yellow, for example) based on the image information is formed on the image carrier 22.

Meanwhile, the rotary developing device 28 rotates so that a developing portion containing a toner of the color corresponding to the electrostatic latent image to be formed on the image carrier 22 (the yellow developing portion 28Y, if the corresponding color is yellow) is positioned at a position opposite the image carrier 22.

Thereafter, the developing portion 28Y develops the electrostatic latent image on the image carrier 22 to form a toner image on the image carrier 22. This toner image is transported toward the transfer position Tr, at which the toner image faces the transfer drum 30, with the rotation of the image carrier 22.

With the start of the image forming operation, feeding of a sheet medium P is also started. Specifically, sheet media P that are picked up from the sheet containing member 18A by the pick-up roller 18B are separated by the separation rollers 18C. The separated sheet media P are forwarded to the transport path 40 by the transporting rollers 18E. The leading-end sensor 18D then detects the leading end portion of each sheet medium P passing thereby and transmits a detection signal to the controlling unit 20.

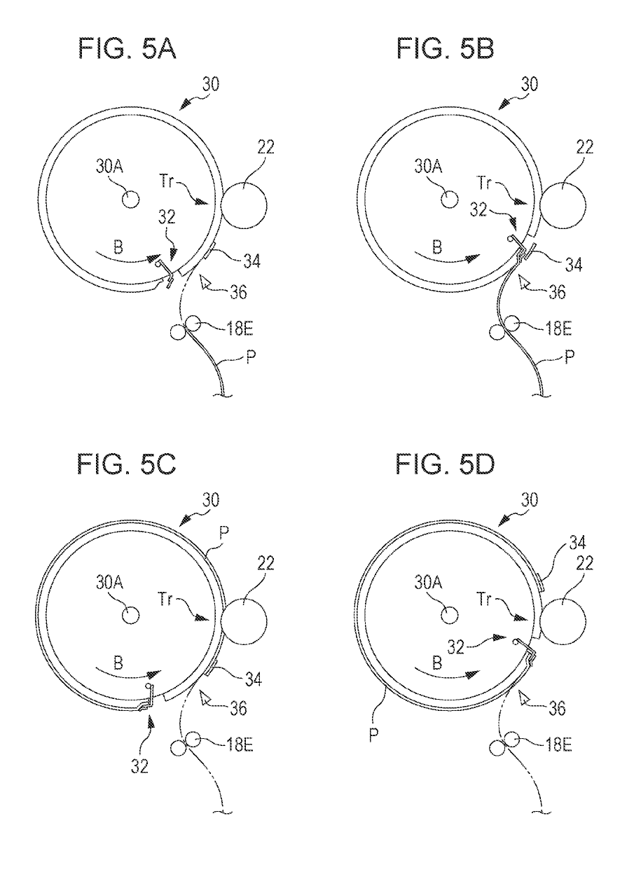

The controlling unit 20 that has received the detection signal controls transportation of the sheet medium P on the basis of the detection signal such that the sheet medium P arrives at the feeding-sheet position Pa at the same time as when the leading-end gripper 32 arrives at the feeding-sheet position Pa (see FIG. 5A).

Here, at the time of feeding the sheet medium P, information on the size of the sheet medium P that has been detected by a sheet-size sensor (not illustrated) is transmitted to the controlling unit 20.

As illustrated in FIG. 5B, the leading-end gripper 32 that has been in the releasing state switches to the gripping state at the same time as when the leading end portion of the sheet medium P arrives at the feeding-sheet position Pa. The leading end portion of the sheet medium P is thus gripped by the leading-end gripper 32.

The leading-end gripper 32 gripping the sheet medium P then passes a position opposite the stationary trailing-end gripper 34. The leading-end gripper 32 having passed the trailing-end gripper 34 then moves toward the transfer position Tr while gripping the sheet medium P.

The sheet medium P that has passed the transfer position Tr while being gripped by the leading-end gripper 32 is consequently wrapped around the transfer drum 30 while being gripped by the leading-end gripper 32, as illustrated in FIG. 5C.

The toner image of the first color (yellow, for example) formed on the image carrier 22 is transferred to the sheet medium P on the transfer drum 30 at the transfer position Tr at which the image carrier 22 and the transfer drum 30 face each other. Part of toner remaining on the image carrier 22 after the transfer is recovered from the image carrier 22 by the cleaning device 46 (see FIG. 7).

Thereafter, the sheet sensor 36 detects the trailing end portion of the sheet medium P passing thereby. The controlling unit 20 that has received a signal from the sheet sensor 36 sends an instruction to the trailing-end gripper 34.

The trailing-end gripper 34 having received the instruction switches from the releasing state to the controlling state to control the trailing end portion of the sheet medium P.

The trailing-end gripper 34 that has switched to the controlling state starts rotating together with the transfer drum 30. In other words, the sheet controlling portion 34A of the trailing-end gripper 34 moves at the same velocity as the peripheral velocity V2 of the transfer drum 30.

As illustrated in FIG. 5D, the trailing-end gripper 34 rotating together with the transfer drum 30 passes the transfer position Tr while controlling the trailing end portion of the sheet medium P.

Likewise, forming and developing of latent images for a second and subsequent colors (magenta and cyan, for example), which precede a final color (black, for example), and transferring of toner images corresponding to the latent images is repeated in accordance with the above-described procedure.

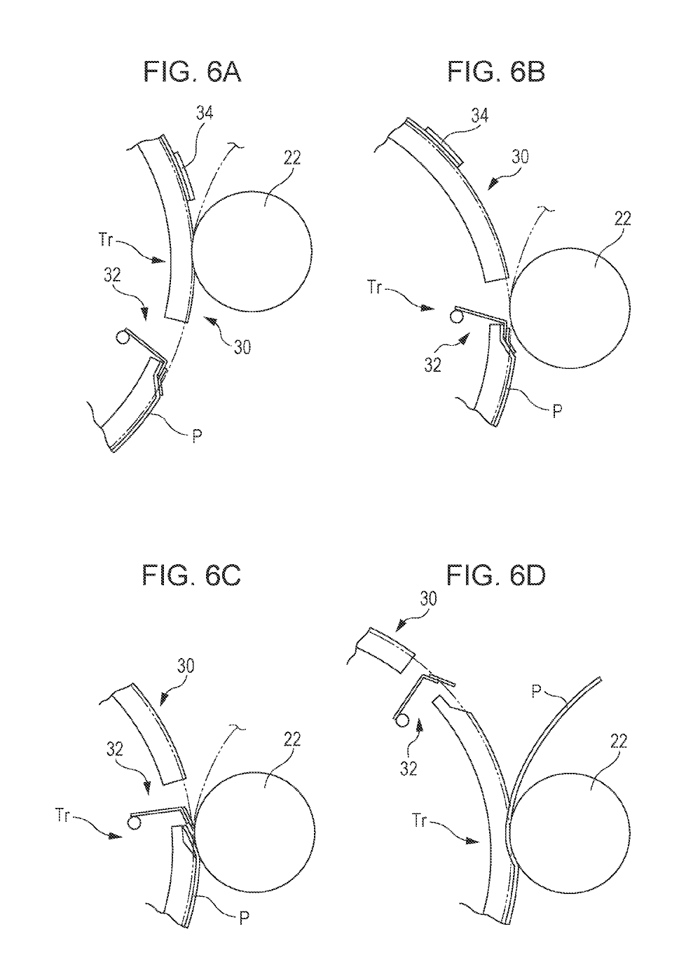

As illustrated in FIGS. 6A and 6B, in the case of transferring a toner image of a final color (black, for example), the leading-end gripper 32 switches from the gripping state to the releasing state at the transfer position Tr, unlike in the case of transferring a toner image of a color that precedes the final color.

As illustrated in FIGS. 6C and 6D, when the leading-end gripper 32 releases the leading end portion of the sheet medium P holding multiple toner images, the leading end portion becomes separated from the transfer drum 30 due to having been nipped by the elastic layer 30C and the image carrier 22.

The sheet medium P whose leading end portion is separated from the transfer drum 30 is transported toward the fixing device 16 illustrated in FIG. 8.

As the sheet medium P is transported further, the trailing-end gripper 34 that controls the trailing end portion of the sheet medium P arrives at the stand-by position. At the stand-by position, the trailing-end gripper 34 switches from the controlling state to the releasing state to release the trailing end portion of the sheet medium P. The trailing-end gripper 34 that has switched to the releasing state stops at the stand-by position.

The toner images on the sheet medium P having been transported to the fixing device 16 are fixed onto the sheet medium P by the fixing device 16. As the sheet medium P is transported further, the sheet medium P becomes separated from the transfer drum 30. The sheet medium P is finally discharged to the discharge portion 42 by the discharging rollers 44.

### Configuration of Related Portion

Description is now given on the shape of a portion of the elastic layer 30C, the leading-end portion of the sheet medium P being gripped between the elastic layer 30C and the leading-end gripper 32, and on the pressing member 50 that presses the leading-end portion of the sheet medium P against the elastic layer 30C.

### Shape of Elastic Layer

As illustrated in FIG. 1A, the leading end portion of the sheet medium P is gripped between a grip surface 56 and a pressing plate 32A of the leading-end gripper 32. When viewed in the drum axis direction, the grip surface 56 is lowered by one step radially inward from a regular surface 58, which is the outermost peripheral surface of the elastic layer 30C.

The grip surface 56 that is lowered by one step is formed so as to be parallel with the regular surface 58, and a supporting surface 60, which is oblique with respect to the grip surface 56 when viewed in the drum axis direction, is formed to connect the grip surface 56 and the regular surface 58. Since the supporting surface 60 is obliquely formed, the elastic layer 30C is gradually pressed by the image carrier 22.

The grip surface 56 and the supporting surface 60 that is adjacent to the grip surface 56 (a tangent at an end of the grip surface 56 and the supporting surface 60) form an obtuse angle when viewed in the drum axis direction. Specifically, the angle α illustrated in FIG. 1A is more than 90° but less than 180°.

### Pressing Member

The pressing member 50 is made of a film-formed resin material having a thickness of 200 μm to 300 μm, for example. Examples of the resin material include polyethylene terephthalate (PET), polyimide, and fluorocarbon resins.

The film-formed pressing member 50 extends along the drum axis direction. An end portion of the pressing member 50 is fixed to a surface of the pressing plate 32A, which is opposite the surface that contacts the grip surface 56, by bonding or some other way.

As illustrated in FIG. 1B, when the leading-end gripper 32 switches to the gripping state, the pressing member 50 is elastically deformed by being pressed against the supporting surface 60. The elastically deformed pressing member 50 presses the leading end side of the sheet medium P against the supporting surface 60 with a restoring force.

A leading end portion of the pressing member 50 that is in a state of pressing the sheet medium P against the elastic layer 30C is located on the outer side of the compressed circumference NL. In other words, the leading end portion of the pressing member 50 is located inside a region in which the image carrier 22 compresses the elastic layer 30C.

### Operations of Configuration of Related Portion

When the sheet medium P whose leading end portion is gripped by the leading-end gripper 32 passes the transfer position Tr, a leading end side of the sheet medium P is likely to rise above the elastic layer 30C at the transfer position Tr.

A conceivable reason why the leading end side of the sheet medium P rises above the elastic layer 30C at the transfer position Tr is as follows. Transporting of the sheet medium P that is nipped by the transfer drum 30 and the image carrier 22 is dominantly performed by using electrostatic attraction of the image carrier 22. Here, since the peripheral velocity V1 of the image carrier 22 is higher than the peripheral velocity V2 of the transfer drum 30, the velocity at which the sheet medium P is transported at the transfer position Tr increases in line with the peripheral velocity of the image carrier 22.

As illustrated in FIG. 1B, however, the leading end side of the sheet medium P is pressed against the supporting surface 60 by the pressing member 50, the leading end side of the sheet medium P is prevented from rising (the position of the leading end side of the sheet medium P becomes stable).

When the leading end side of the sheet medium P is prevented from rising, toner images of different colors are started to be formed at a stable position, so that misregistration between the colors is avoided.

The pressing member 50 presses the leading end side of the sheet medium P against the supporting surface 60 with the restoring force. The leading end side of the sheet medium P is thus more effectively prevented from rising than in the case where the leading end side of the sheet medium P is simply brought into contact with the supporting surface 60.

The pressing member 50 presses the leading end side of the sheet medium P against the supporting surface 60 with the restoring force. A pressing member 50 having a smaller thickness is also capable of exerting, on the leading end side of the sheet medium P, such a pressing force that is similar to that in the case where the thickness of the pressing member 50 is not reduced.

Since the pressing member 50 is made of a resin film, the pressing member 50 bends when being pressed by the image carrier 22 at the transfer position Tr. Thus, the image carrier 22 is prevented from being damaged by contacting the pressing member 50.

Since the pressing member 50 bends by being contacted by the image carrier 22, the pressing member 50, unlike the leading-end gripper 32, is allowed to be positioned within a region in which the elastic layer 30C is compressed. By using the pressing member 50, a larger proportion of the leading end side of the sheet medium P is controlled so as to lie on the elastic layer 30C.

The pressing member 50 is attached to the leading-end gripper 32. Accordingly, while the leading-end gripper 32 grips the leading end portion of the sheet medium P, the leading end side of the sheet medium P is pressed against the supporting surface 60 by the pressing member 50 without using a driving source for simply driving the pressing member 50 alone.

The grip surface 56 and the supporting surface 60 are formed so as to form an obtuse angle when viewed in the drum axis direction. For this reason, even in the case where the sheet medium P is pulled toward the trailing end portion of the sheet medium P, the leading end portion of the sheet medium P that is gripped between the grip surface 56 and the leading-end gripper 32 is more efficiently prevented from moving than in the case where the grip surface and the supporting surface are formed on the same plane.

Specifically, in the case where the grip surface and the supporting surface are formed on the same plane, if the sheet medium P is pulled in a direction along the supporting surface to remove the sheet medium P from between the grip surface and the leading-end gripper, the load with which the sheet medium P is pulled in the direction along the supporting surface is directly applied to the leading end portion of the sheet medium P.

In the case where the grip surface 56 and the supporting surface 60 form an obtuse angle, on the other hand, if the sheet medium P is pulled in a direction along the supporting surface 60 to remove the sheet medium P from between the grip surface 56 and the leading-end gripper 32, a component of the load with which the sheet medium P is pulled in the direction along the supporting surface 60 is applied to the leading end portion of the sheet medium P.

Accordingly, the load applied to the leading end portion of the sheet medium P in this case is smaller than that in the case where the grip surface and the supporting surface are formed on the same plane. For this reason, in the case where the grip surface 56 and the supporting surface 60 are formed so as to form an obtuse when viewed in the drum axis direction, the leading end portion of the sheet medium P that is gripped between the grip surface 56 and the leading-end gripper 32 is more effectively prevented from moving.

As described above, the peripheral velocity V1 of the image carrier 22 is higher than the peripheral velocity V2 of the transfer drum 30, and the sheet medium P is transported at the transfer position Tr at the same velocity as the peripheral velocity V1 of the image carrier 22. For this reason, toner images are transferred from the image carrier 22 to the sheet medium P at a stable transfer velocity.

The leading-end gripper 32 is separated from the image carrier 22 even when the leading-end gripper 32 is positioned at the transfer position Tr, and thus the image carrier 22 is not damaged by the leading-end gripper 32.

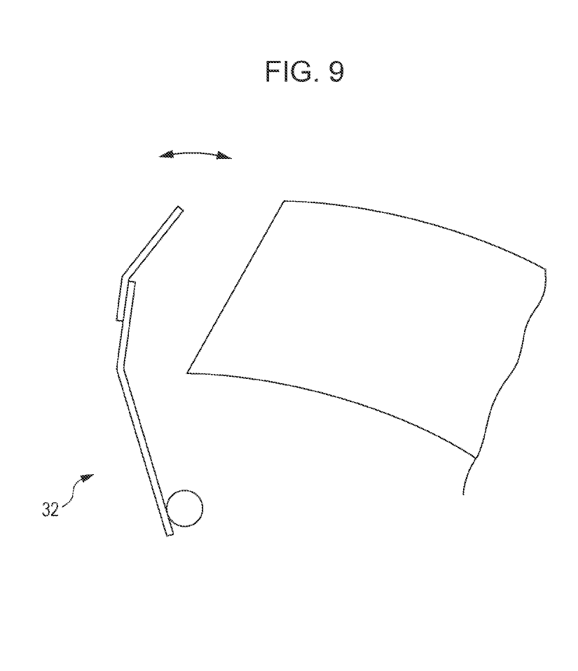

Although a specific exemplary embodiment of the invention has been described in detail, it is obvious to practitioners skilled in the art that the present invention is not limited to the exemplary embodiment and that various other exemplary embodiments can be made within the scope of the invention. For example, in the exemplary embodiment, the grip surface 56 and the supporting surface 60 are formed so as to form an obtuse angle. The grip surface and the supporting surface, however, may be formed on the same plane. In this case, the film-formed pressing member may be formed so as to be bent toward the supporting surface, as illustrated in FIG. 9.

In the exemplary embodiment, the leading end side of the sheet medium P is pressed against the supporting surface 60 by bending the pressing member 50 and using the restoring force of the pressing member 50. However, the leading end side of the sheet medium P may be controlled so as to lie on the supporting surface 60 while the pressing member is not bent.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image carrier on whose surface toner images are formed while the image carrier is rotating;
a transfer body around whose outer peripheral surface a recording medium is wrapped, the transfer body rotating at a peripheral velocity that is lower than a peripheral velocity of the image carrier, the transfer body transporting the recording medium, while rotating, to a transfer position at which the transfer body faces the image carrier, the outer peripheral surface including an elastic layer having a cutout being formed therein, the elastic layer being elastically deformed by being pressed by the image carrier at the transfer position while supporting the recording medium;
a gripper that is disposed in a cutout region in which the cutout is formed, the gripper gripping a leading end portion of the recording medium wrapped around the transfer body and releasing the leading end portion of the recording medium that is to be separated from the transfer body; and
a pressing member at least part of which is located closer to a trailing-end side of the recording medium than the gripper, the pressing member pressing a leading end side of the recording medium, whose leading end portion is gripped by the gripper, against the elastic layer.

2. The image forming apparatus according to claim 1,
wherein the gripper is located outside a region in which the image carrier compresses the elastic layer, and
wherein at least part of the pressing member is located inside the region in which the image carrier compresses the elastic layer, and the pressing member having moved to the transfer position is elastically deformed by being pressed by the image carrier.

3. The image forming apparatus according to claim 1,
wherein the pressing member is supported by the gripper, and the pressing member presses the leading end side of the recording medium against the elastic layer while the gripper grips the leading end portion of the recording medium.

4. The image forming apparatus according to claim 2,
wherein the pressing member is supported by the gripper, and the pressing member presses the leading end side of the recording medium against the elastic layer while the gripper grips the leading end portion of the recording medium.

5. The image forming apparatus according to claim 1,
wherein a grip surface and a supporting surface that is adjacent to the grip surface form an obtuse angle when viewed in a direction of a rotation axis of the transfer body, the grip surface being formed on the elastic layer of the transfer body, the leading end portion of the recording medium being gripped between the grip surface and the gripper, the recording medium being sandwiched between the supporting surface and the pressing member.

6. The image forming apparatus according to claim 2,
wherein a grip surface and a supporting surface that is adjacent to the grip surface form an obtuse angle when viewed in a direction of a rotation axis of the transfer body, the grip surface being formed on the elastic layer of the transfer body, the leading end portion of the recording medium being gripped between the grip surface and the gripper, the recording medium being sandwiched between the supporting surface and the pressing member.

7. The image forming apparatus according to claim 3,
wherein a grip surface and a supporting surface that is adjacent to the grip surface form an obtuse angle when viewed in a direction of a rotation axis of the transfer body, the grip surface being formed on the elastic layer of the transfer body, the leading end portion of the recording medium being gripped between the grip surface and the gripper, the recording medium being sandwiched between the supporting surface and the pressing member.

8. The image forming apparatus according to claim 4,
wherein a grip surface and a supporting surface that is adjacent to the grip surface form an obtuse angle when viewed in a direction of a rotation axis of the transfer body, the grip surface being formed on the elastic layer of the transfer body, the leading end portion of the recording medium being gripped between the grip surface and the gripper, the recording medium being sandwiched between the supporting surface and the pressing member.

9. The image forming apparatus according to claim 1,
wherein a clearance exists between the gripper and the image carrier when the image carrier presses the elastic layer.

10. The image forming apparatus according to claim 9,
wherein the pressing member deforms when the image carrier presses the pressing member toward the elastic layer.

11. The image forming apparatus according to claim 1,
wherein the transfer body rotates a plurality of times to sequentially transfer the toner images formed on the surface of the image carrier to the recording medium.

12. The image forming apparatus according to claim 5,
wherein the grip surface is lower than an outermost periphery of the elastic layer.

13. An image forming apparatus comprising:
an image carrier that rotates and on which toner images are formed;
a transfer body that transports a recording medium to a transfer position at which the transfer body faces the image carrier while rotating and that includes an elastic layer on a periphery, the elastic layer being pressed by the image carrier at the transfer position, a portion of the elastic layer being cut out, the recording medium being wrapped around the transfer body;
a gripper that is disposed in a cutout region in which the elastic layer is cut out, the gripper gripping a leading end portion of the recording medium, wrapped around the transfer body, with an end portion of the gripper; and
a pressing member that is disposed at the end portion of the gripper, the pressing member pressing a leading end side of the recording medium against the elastic layer.
